(19) United States
(12) Patent Application Publication
(10) Pub. No.: US 2020/0249815 A1
(43) Pub. Date: Aug. 6, 2020

(54) DISPLAY DEVICE AND METHOD FOR CONTROLLING DISPLAY DEVICE

(71) Applicant: JOLED INC., Tokyo (JP)

(72) Inventor: Masanori OHARA, Tokyo (JP)

(73) Assignee: JOLED INC., Tokyo (JP)

(21) Appl. No.: 16/774,655

(22) Filed: Jan. 28, 2020

(30) Foreign Application Priority Data
Feb. 5, 2019 (JP) 2019-018343
Oct. 3, 2019 (JP) 2019-182978

(51) Int. Cl. G06F 3/041; G09G 3/3266

(52) U.S. Cl. CPC G06F 3/04184; G06F 3/0446; G09G 3/3266

(57) ABSTRACT

A display device includes: a display panel; a touch panel opposing the display panel; and a controller. The display panel includes: pixels arranged in rows and columns; and scan lines that are respectively arranged for the rows and select a pixel row to which data voltages corresponding to a video signal is to be written and a pixel row for performing black display. The touch panel includes scan electrodes respectively elongated in parallel to the scan lines and receiving scan signals. The controller causes a scan signal to be applied to a scan electrode overlapping the pixel row performing the black display in a plan view of the touch panel.

### CROSS REFERENCE TO RELATED APPLICATIONS

The present application is based on and claims priority of Japanese Patent Application No. 2019-018343 filed on Feb. 5, 2019 and Japanese Patent Application No. 2019-182978 filed on Oct. 3, 2019. The entire disclosures of the above-identified applications, including the specifications, drawings and claims are incorporated herein by reference in their entirety.

### FIELD

The present disclosure relates to a display device and a method for controlling the display device.

### BACKGROUND

In recent years, mobile terminals and smartphones each including a display device having a touch panel disposed on a display panel to improve the operability have achieved good popularity. For example, Patent Literature 1 discloses as a display device not only a liquid crystal display but also an organic electro-luminescence (EL) display device that performs display on an organic EL display.

### CITATION LIST

### Patent Literature

Patent Literature 1: Japanese Unexamined Patent Application Publication No. 2010-2.0315

### SUMMARY

### Technical Problem

Providing a touch panel on the display panel, however, causes, for example, a detection signal for detecting a position of touch operation performed on the touch panel to be transmitted as noise to the display panel, resulting in a decrease in display quality of the display panel in some cases. Furthermore, variation in a VCATH voltage resulting from a light emission current that causes a light emitting element provided in the display panel to emit light is transferred as noise to the touch panel, thereby decreasing sensing performance of the touch panel in some cases.

An object of the present disclosure is to provide a display device capable of improving display quality and sensing performance and a method for controlling the display device.

### Solution to Problem

In order to achieve the above object, in accordance with an aspect of the present disclosure, there is provided a display device, including: a display panel; a touch panel opposing the display panel; and a controller, wherein the display panel includes: a plurality of pixels arranged in rows and columns; and a plurality of scan lines respectively arranged for the rows, the plurality of scan lines selecting, from the rows, a pixel row to which data voltages corresponding to a video signal is to be written and a pixel row for performing black display, the touch panel includes a plurality of scan electrodes respectively elongated in parallel to the plurality of scan lines and receiving scan signals, and the controller causes a scan signal to be applied to a scan electrode overlapping the pixel row performing the black display among the plurality of scan electrodes in a plan view of the touch panel.

In accordance with another aspect of the present disclosure, there is provided a control method for use in a display device, the display device including: a display panel; and a touch panel opposing the display panel; wherein the display panel includes: a plurality of pixels arranged in rows and columns; a plurality of scan lines respectively arranged for the rows, the plurality of scan lines selecting, from the rows, a pixel row to which data voltages corresponding to a video signal is to be written and a pixel row for performing black display, and the touch panel includes: a plurality of scan electrodes respectively elongated in parallel to the plurality of scan lines and receiving scan signals, the control method including: applying a scan signal to a scan electrode overlapping the pixel row performing the black display among the plurality of scan electrodes in a plan view of the touch panel.

### Advantageous Effects

The display device and the method for controlling the display device according to the aspects of the present disclosure can improve display quality and sensing performance.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a block diagram showing an example of a functional schematic configuration of a display device according to Embodiment 1.

FIG. 2 is a block diagram showing an example of a functional detailed configuration of the display device according to Embodiment 1.

FIG. 3A is a circuit diagram showing an example of the configuration of a touch panel according to Embodiment 1.

FIG. 3B shows a variety of signals in the touch panel according to Embodiment 1.

FIG. 4 is a circuit diagram showing an example of the configuration of a pixel circuit according to Embodiment 1.

FIG. 5 is a plan view diagrammatically showing an example of the structure of the pixel circuit according to Embodiment 1.

FIG. 6 is a first view for describing a problem with a display device according to related art.

FIG. 7 is a circuit diagram showing an example of the configuration of the pixel circuit according to Embodiment 1.

FIG. 8 is a second view for describing the problem with the display device according to related art.

FIG. 9 is a plan view diagrammatically showing the action of the display device according to Embodiment 1.

FIG. 10A is a timing chart showing an example of a method for driving the pixel circuit according to Embodiment 1.

FIG. 10E3 is a timing chart showing an example of a method for driving the display device according to Embodiment 1.

FIG. 11 is a plan view showing the time-course action of the display device according to Embodiment 1.

FIG. 12 is a block diagram showing an example of a functional detailed configuration of a display device according to Embodiment 2.

FIG. 13 is a plan view diagrammatically showing the action of the display device according to Embodiment 2.

FIG. 14 is a timing chart showing an example of a method for driving the display device according to Embodiment 2.

FIG. 15 is a flowchart showing the action of switching a scan mode in the display device according to Embodiment 2.

FIG. 16 is a flowchart showing the action of switching the scan mode in a display device according to a variation of Embodiment 2.

FIG. 17A shows a first example of a predetermined pattern.

FIG. 17B shows a second example of the predetermined pattern.

FIG. 17C shows a third example of the predetermined pattern.

FIG. 17D shows a fourth example of the predetermined pattern.

### DESCRIPTION OF EMBODIMENTS

Hereinafter, certain exemplary embodiments will be described in detail with reference to the accompanying Drawings. The following embodiments are specific examples of the present disclosure. The numerical values, shapes, materials, elements, arrangement and connection configuration of the elements, steps, the order of the steps, etc., described in the following embodiments are merely examples, and are not intended to limit the present disclosure.

Note that the respective figures are schematic diagrams and are not necessarily precise illustrations. Additionally, components that are essentially the same share like reference signs in the figures. Accordingly, overlapping explanations thereof are omitted or simplified.

### Embodiment 1

### [1.1 Configuration of Display Device]

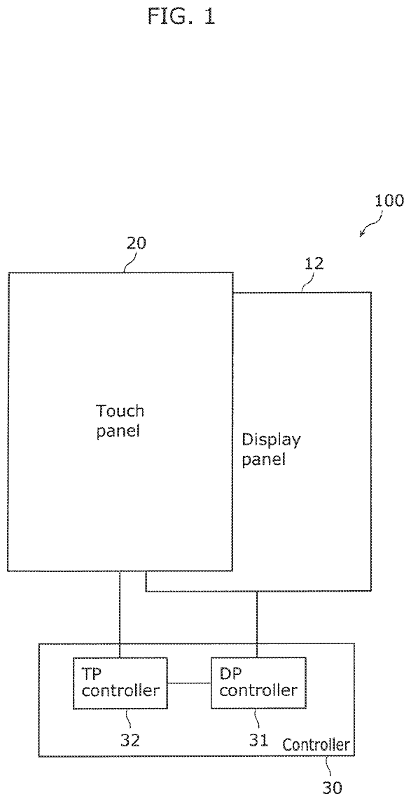

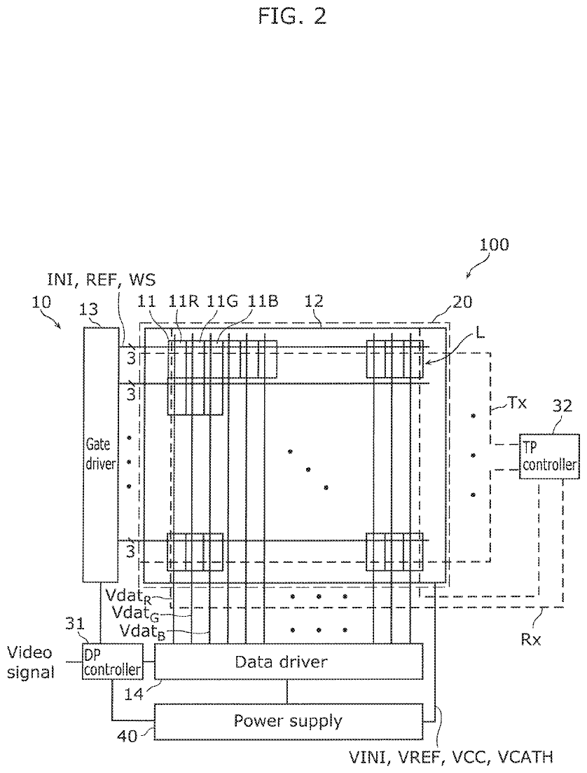

The configuration of a display device according to the present embodiment will be described with reference to FIGS. 1 to 3B. FIG. 1 is a block diagram showing an example of a functional schematic configuration of a display device 100 according to the present embodiment. FIG. 2 is a block diagram showing an example of a functional detailed configuration of the display device 100 according to the present embodiment. In the following description, a signal and a wire that transmits the signal are referred to by the same reference character in some cases for simplicity. For the same reason, a circuit and a region where the circuit is formed are referred to by the same reference character in some cases. FIG. 1 shows only a display panel 12, a touch panel 20, and a controller 30 among the components provided in the display device 100. FIG. 2 shows the configuration of the touch panel 20 expressed with a broken line.

As shown in FIGS. 1 and 2, the display device 100 includes a display module 10, the touch panel 20, the controller 30, and a power supply 40. The display module 10 includes the display panel 12 (display section), a gate driver 13, and a data driver 14.

The display panel 12 is so configured that a plurality of pixel circuits 11 (pixels) are arranged in rows and columns (matrix). That is, the display panel 12 includes a plurality of pixel rows L. The pixel circuits 11 each include sub-pixel circuits 11R, 11G, and 11B (sub-pixels) corresponding to emitted light colors, R, G, and B. The present embodiment will be described with reference to a case where the plurality of pixels that form the plurality of pixel rows L each include an organic EL element as a light emitting element, but not necessarily. The display panel 12 may include element of quantum-dot light emitting diodes (QLEDs) as the light emitting elements.

The rows of the matrix are each provided with three control signal lines INI, REF, and WS connected to a plurality of pixel circuits 11 disposed in the same row. The control signal lines INI, REF, and WS transmit control signals INI, REF, and WS supplied from the gate driver 13 to each of the pixel circuits 11. The number of control signal lines and control signals are presented by way of example and are not limited to those in the present example. The control signal lines INI, REF, and WS are examples of scan lines.

The scan lines are respectively arranged for the plurality of pixel rows L and provided to select a pixel row L to which data voltages corresponding to a video signal are to be written. In the present embodiment, at least one of the plurality of pixel rows L performs black display at a certain point of time. It can therefore also be said that the scan lines are respectively arranged for the plurality of pixel rows L and provided to select a pixel row to which data voltages corresponding to a video signal are to be written and select a pixel row L for performing black display. The pixel row L for performing black display is formed of one or more pixel rows L adjacent to each other.

The columns of the matrix are each provided with three data signal lines Vdat_{R}, Vdat_{G}, and Vdat_{B} connected to a plurality of pixel circuits 11 disposed in the same column. The data signal lines Vdat_{R}, Vdat_{G}, and Vdat_{B} transmit data signals Vdat_{R}, Vdat_{G}, and Vdat_{B} relating to the emitted RGB light luminance values supplied from the data driver 14 to the pixel circuits 11.

In FIG. 2, the gate driver 13 is disposed on one side of the display panel 12 and may instead be disposed on both sides thereof. The data driver 14 may be implemented in the display panel 12 in the chip-on-glass (COG) or chip-on-film (COF) form.

The touch panel 20 is a sensor that is so disposed as to face the display panel 12 and detects, for example, a coordinate position where the touch panel 20 is pressed with a touch pen, a finger, or any other object and drag operation performed therewith. The touch panel 20 is bonded to the display panel 12 with an adhesive (optical clear adhesive (OCA), for example) and overlaid thereon.

The touch panel 20 includes a plurality of scan electrodes Tx (drive lines), which are arranged in parallel to the plurality of scan lines and receive scan signals. The touch panel 20 further includes a plurality of detection electrodes Rx (sense lines), which intersect the plurality of scan electrodes Tx and detect detection signals. The scan electrodes Tx and the detection electrodes Rx are so disposed on a translucent substrate (not shown) as to be isolated from each other. The scan electrodes Tx and the detection electrodes Rx each comprise a translucent, electrically conductive material. The scan electrodes Tx and the detection electrodes Rx are each formed, for example, of a transparent electrically conductive film made, for example, of indium tin oxide (ITO). One of the scan electrodes Tx and the detection electrodes Rx may each include a metal bridge made, for example, of molybdenum, which is highly translucent. The touch panel 20 is, for example, a capacitance-type touch panel. In FIG. 2, the scan electrodes Tx and the detection electrodes Rx are each expressed by a straight line for convenience but do not each necessarily have a specific shape. The scan electrodes Tx and the detection electrodes Rx may include, for example, a diamond pattern.

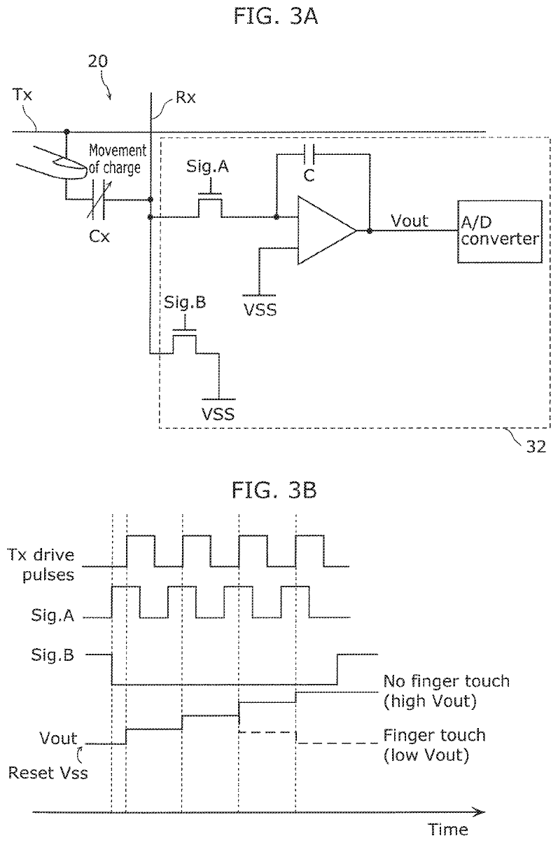

FIG. 3A is a circuit diagram showing an example of the configuration of the touch panel 20 according to the present embodiment. FIG. 3B shows a variety of signals in the touch panel 20 according to the present embodiment, A touch position detection method employed by the touch panel 20 may be a method of related art and will be described in a simplified manner.

A TP controller 32 includes two transistors, an operational amplifier, an integral capacity C connected to the input/output terminals of the operational amplifier in parallel thereto, and an A/D converter that converts output voltage Vout from the operational amplifier into a digital signal, as shown in FIG. 3A. Although not shown, the TP controller 32 includes, for example, a computation section that computes the touch position based on the digital signal output from the A/D converter. Sig.A represents a signal for switching the state of conduction between the detection electrodes Rx and the operational amplifier from a conducted state to a non-conducted state and vice versa. When Sig.A is High, charge from the touch panel 20 is accumulated in the integral capacity C. The output voltage Vout at the output terminal of the operational amplifier is determined based on the charge accumulated in the integral capacity C. Sig.B is a signal for resetting capacitance Cx of the touch panel 20 (discharging charge accumulated in capacity).

The capacitance-type touch panel 20 senses a change in the capacitance that occurs when the TP controller 32 supplies a scan electrode Tx with Tx drive pulses (example of scan signals) and evaluates whether or not the touch panel 20 has been touched, as shown in FIGS. 3A and 3B. For example, specific coordinates on the touch panel 20 at which a finger is touching are detected from the detection electrode Rx in the form of the amount of change in the charge in cross sense capacity at the intersection of the scan electrode Tx and the detection electrode Rx cross.

In a state in which the touch panel 20 is not touched with a finger, the detection electrode Rx is not affected by a change in the capacity resulting from finger touch. The output voltage Vout having a high voltage value is therefore output from the operational amplifier to the A/D converter, as indicated by the “no finger touch” in FIG. 3B. On the other hand, in a state in which the touch panel 20 is touched with a finger, the detection electrode Rx is affected by a change in the capacity resulting from the finger touch. The output voltage Vout having a low voltage value is therefore output from the operational amplifier to the A/D converter, as indicated by the “finger touch” in FIG. 3B.

Although not shown, an FPC or TCP connector or any other connector may be attached to the substrate of the touch panel 20, or an IC (TP controller 32, for example) may be mounted on the substrate, for example, by using the COG method. The substrate of the touch panel 20 to which a connector is attached or on which an IC is mounted is also simply referred to as a touch panel in the present specification.

The controller 30 includes a DP controller 31, which controls the display panel 12, and the TP controller 32, which controls the touch panel 20, with reference to FIGS. 1 and 2 again. The DP controller 31 externally receives a video signal and supplies the gate driver 13 and the data driver 14 with control signals for displaying an image of each frame of the video signal on the display panel 12. The TP controller 32 supplies a scan electrode Tx with a scan signal, measures the cross sense capacity at the intersection of the scan electrode Tx and a detection electrode Rx, and calculates input coordinates of the position where touch operation has been performed (touch position) based on the capacity value at the intersection of the electrodes.

The controller 30 may further include an integrated controller (not shown) that controls the DP controller 31 and the TP controller 32. For example, when input coordinates are input from the TP controller 32, the integrated controller may output a display image generated in accordance with the touch operation to the DP controller 31.

The power supply 40 supplies the display panel 12, the gate driver 13, the data driver 14, and the controller 30 with electric power for operation. The power supply 40 supplies the display panel 12, for example, with reference voltages VINI and VREF, a positive power supply voltage VCC, and a negative power supply voltage VCATH (hereinafter also simply referred to as VCATH voltage).

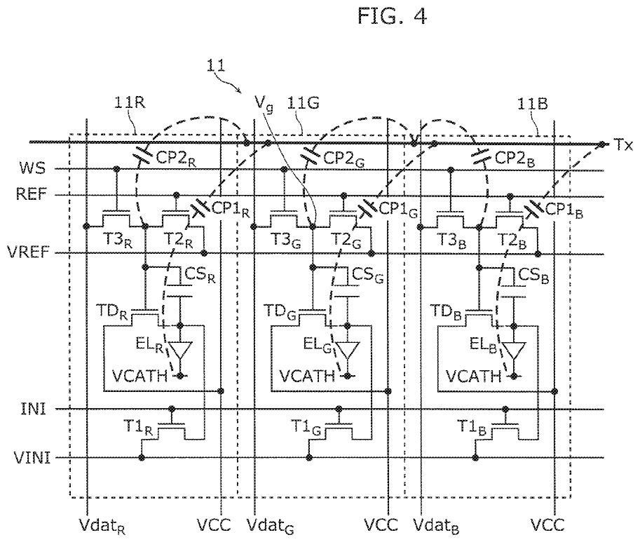

The detailed configuration of the pixel circuits 11 and the problem of the display device according to the related art will now be described with reference to FIGS. 4 to 8. FIG. 4 is a circuit diagram showing an example of the configuration of each of the pixel circuits 11 according to the present embodiment.

The sub-pixel circuits 11R, 11G, and 11B, which form each of the pixel circuits 11, have the same configuration, as shown in FIG. 4. The configuration of the pixel circuits 11 will be described below with reference to the sub-pixel circuit 11R.

The sub-pixel circuit 11R includes an initializing transistor T1_{R}, a compensation transistor T2_{R}, a writing transistor T3_{R}, holding capacity CS_{R}, a drive transistor TD_{R}, and a light emitting element EL_{R}. The sub-pixel circuit HR further includes the control signal lines INI, REF, and WS, reference voltage lines VINI and VREF, the data signal line Vdat_{R}, a positive power supply line VCC, and a negative power supply line VCATH.

The initializing transistor T1_{R} is turned on in accordance with the control signal INI to set the source node of the drive transistor TD_{R} at the reference voltage VINI.

The compensation transistor T2_{R} is turned on in accordance with the control signal REF to set the gate node of the drive transistor TD_{R} at the reference voltage Vref.

The writing transistor T3_{R} is turned on in accordance with the control signal WS to cause the holding capacity CS_{R} to hold the voltage carried by the data signal Vdat_{R}.

The drive transistor TD_{R} supplies the light emitting element EL_{R} with a current in accordance with the voltage held by the holding capacity CS_{R}. The light emitting element EL_{R} thus emits light having luminance indicated by the data signal Vdat_{R}.

The sub-pixel circuits 11G and 11B also have the same configuration as that of the sub-pixel circuit 11R.

The sub-pixel circuits 11R, 11G, and 11B therefore hold the data signals Vdat_{R}, Vdat_{G}, and Vdat_{B} at the same timing in accordance with the same control signals INI, REF, and WS, and the light emitting elements EL_{R}, EL_{G}, and EL_{B} emit light having luminance according to the held data signals.

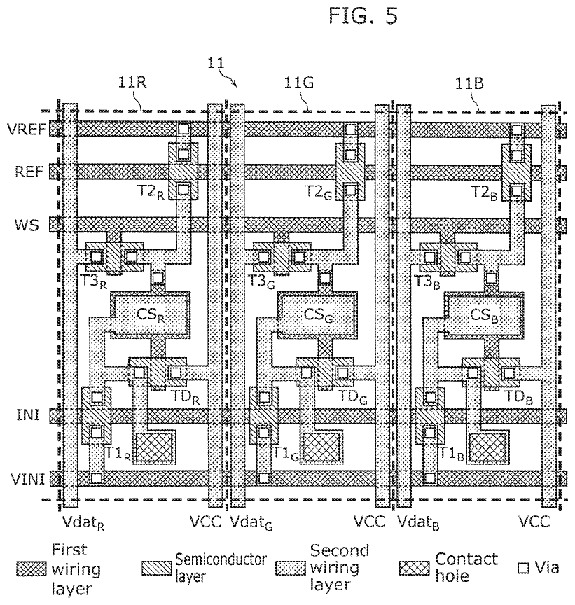

FIG. 5 is a plan view diagrammatically showing an example of the structure of each of the pixel circuits 11 according to the present embodiment. The sub-pixel circuits 11R, 11G, and 11B are formed in three sub-pixel regions 11R, 11G, and 11B, into which the pixel region 11 is divided, as shown in FIG. 5.

The pixel circuit 11 is formed, for example, of a first wiring layer, a semiconductor layer, and a second wiring layer disposed on the substrate in the presented order. The first wiring layer is primarily used as one electrode of each of the control signal lines INI, REF, and WS, the reference voltage lines VINI and VREF, and the holding capacities CS_{R}, CS_{G}, and CS_{B} and the gate electrode of each of the transistors. The semiconductor layer is used as the channel region of each of the transistors. The second wiring layer is primarily used as the other electrode of each of the data signal lines Vdat_{R}, Vdat_{G}, and Vdat_{B}, the positive power supply line VCC, and the holding capacities CS_{R}, CS_{G}, and CS_{B} and the source and drain electrodes of each of the transistors. The different layers are connected to each other via vias.

The light emitting element EL_{R}, EL_{G}, and EL_{B} provided in the pixel circuit 11 emit light having luminance according to the data signals Vdat_{R}, Vdat_{G}, and Vdat_{B} held in the holding capacities CS_{R}, CS_{G}, and CS_{B} at the same timing in accordance with the same control signals INI, REF, and WS.

Although not shown, a planarizing layer is so provided as to cover the substrate, the first wiring layer, the semiconductor layer, and the second wiring layer, and the light emitting element EL_{R}, EL_{G}, and EL_{B} are formed on the planarizing layer.

A description will be made of a decrease in the display quality and sensing performance that occur in the thus configured pixel circuit 11.

Referring to FIG. 4 again, a parasitic capacitance CP2_{R} is present between the gate node of the drive transistor TD_{R} and the scan electrode Tx of the touch panel 20. Similarly, parasitic capacitances CP2_{G} and CP2_{B} are present between the gate nodes of the drive transistors TD_{G}, TD_{B} and the scan electrode Tx of the touch panel 20. Parasitic capacitances CP1_{R}, CP1_{G}, and CP1_{B} are present between the negative power source line VCATH and the scan electrode Tx of the touch panel 20. In the following description, the parasitic capacitances CP1_{R}, CP1_{G}, and CP1_{B} are collectively referred to as a parasitic capacitance CP1, and the parasitic capacitances CP2_{R}, CP2_{G}, and CP2_{B} are collectively referred to as a parasitic capacitance CP2 in some cases.

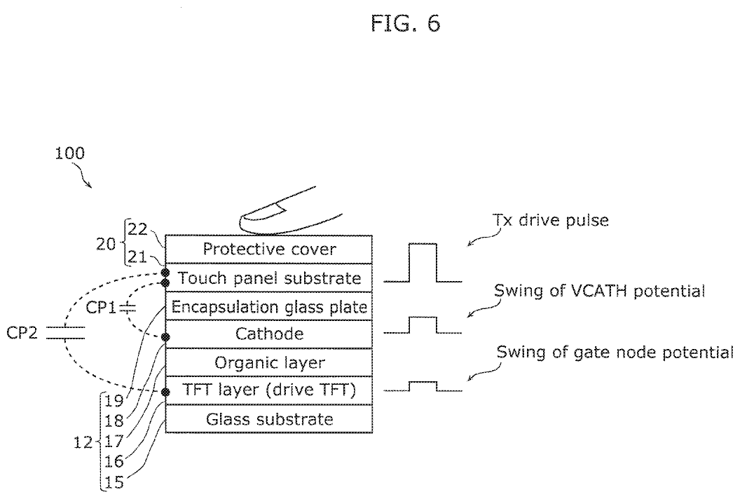

An effect resulting from the parasitic capacitances shown in FIG. 4 will be described with reference to FIG. 6. FIG. 6 is a first view for describing the problem with the display device according to the related art. FIG. 6 shows a schematic configuration of the display device viewed along the direction facing the side surface of the display device. The configuration of the display device according to the related art is the same as that of the display device 100 according to the present embodiment. The adhesive that bonds the display panel 12 and the touch panel 20 to each other and other objects are omitted in FIG. 6. The display device according to the related art means a display device in which the operation of driving the touch panel 20 (sequential sensing in scan direction) is asynchronous with the operation of driving the display panel 12 (gate line sequential driving in scan direction).

The display device 100 includes a touch panel substrate 21, a protective cover 22, a glass substrate 15, a TFT layer 16, an organic layer 17, a cathode 18, and an encapsulation glass plate 19, as shown in FIG. 6. The touch panel substrate 21 and the protective cover 22 are part of the components that form the touch panel 20, and the glass substrate 15, the TFT layer 16, the organic layer 17, the cathode 18, and the encapsulation glass plate 19 are part of the components that form the display panel 12. The configurations of the touch panel 20 and the display panel 12 (organic EL panel in present embodiment) may each be a known configuration and will not be described in detail.

The touch panel 20 is configured by layering the touch panel substrate 21 and the protective cover 22 on each other in the presented order. The touch panel substrate 21 is a substrate on which the scan electrodes Tx, the detection electrodes Rx, and other components are formed. The touch panel substrate 21 comprises a translucent material. The touch panel substrate 21 comprises, for example, a glass or a film. The protective cover 22 is a member that covers the touch panel substrate 21 to protect the touch panel substrate 21. The protective cover 22 is formed of an insulative, translucent member. The protective cover 22 comprises, for example, a glass or a film.

The display panel 12 is configured by layering the glass substrate 15, the TFT layer 16, the organic layer 17, the cathode 18, and the encapsulation glass plate 19 on each other in the presented order. The glass substrate 15 is a substrate on which the TFT layer 16 and other components are formed. The TFT layer 16 is a layer for active driving and is formed, for example, of three electrodes, the gate, the source, and the drain, a semiconductor layer, and a passivation film. The organic layer 17 includes at least an organic light emitting layer containing an organic light emitting material and further includes a hole transport layer, a hole injection layer, an electron transport layer, and/or an electron injection layer as required. The organic layer 17 is so disposed as to be sandwiched between an anode (not shown) and the cathode 18. The anodes of the light emitting element EL_{F}, EL_{G}, and EL_{B} are electrodes (anodes) connected to the source electrodes of the drive transistor TD_{R}, TD_{G}, and TD_{B}, respectively, via contact holes that are open through the planarizing layer. The light emitting element EL_{R}, EL_{G}, and EL_{B} are each formed of the anode, the organic layer 17, and the cathode 18.

The cathode 18 is an electrode (cathode) common to the light emitting element EL_{R}, EL_{G}, and EL_{B} and forms the negative power supply line VCATH, which is a single transparent, planar electrode extending across the entire display panel 12. The negative power supply line VCATH is connected to the power supply 40 at the outer circumferential edge of the display panel 12. The cathode 18 comprises a light transmissive, electrically conductive material and is formed, for example, of a transparent electrically conductive film made, for example, of an indium tin oxide (ITO) or an indium zinc oxide (IZO).

Drive currents supplied from the drive transistors TD_{R}, TS_{G}, and TD_{B} to the anodes of the light emitting element EL_{R}, EL_{G}, and EL_{B} cause the organic layers 17 of the light emitting element EL_{R}, EL_{G}, and EL_{B} to emit light, flow through the negative power supply line VCATH (cathode 18), and return to the power supply 40. The encapsulation glass plate 19 is a glass substrate so provided as to face the glass substrate. The encapsulation glass plate 19 may be made, for example, of an inorganic material, such as a silicon oxide and a silicon nitride.

In the thus configured display device 100, when Tx driving pulses are supplied to a scan electrode Tx of the touch panel 20 that is a scan electrode Tx on an illuminating pixel region (region formed of one or more pixel rows L adjacent to each other, for example) in the display panel 12, and the value of a Tx driving pulse changes from High to Low and vice versa, the display panel 12 is affected by the change in the form of voltage noise, resulting in variation in display luminance. Since the touch panel 20 scans the scan electrodes Tx in the scan direction, the variation in display luminance is undesirably visible as scroll noise, resulting in a large decrease in the display quality of the display panel 12.

For example, when the Tx driving pulses are supplied to the scan electrode Tx located on the region of an illuminating pixel circuit 11 (pixel) in the display panel 12, the VCATH potential at the cathode 18 and the gate node potential at the drive transistors TD_{R}, TD_{G}, and TD_{B} undesirably vary (swing), as shown in FIG. 6. The light emission current in the pixel circuit 11 therefore varies, and the variation is visually recognized as display noise. The VCATH potential and the gate node potential at the driving transistors may be fixed irrespective of the values of the Tx driving pulses, High or Low, but the potential varies in accordance with the Tx driving pulses.

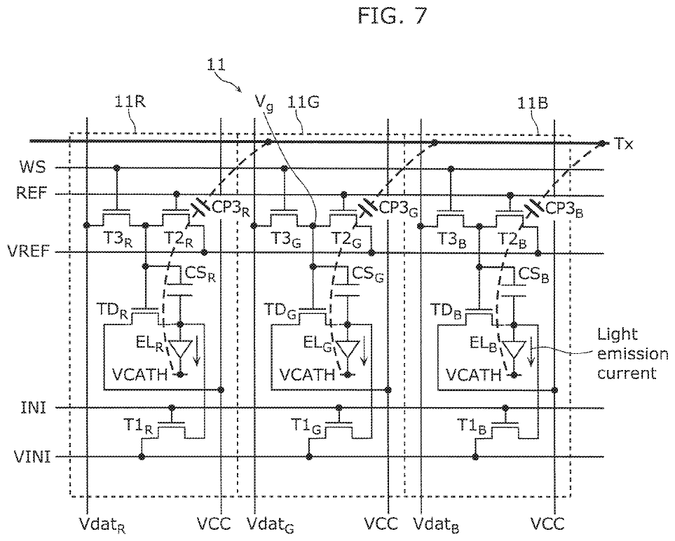

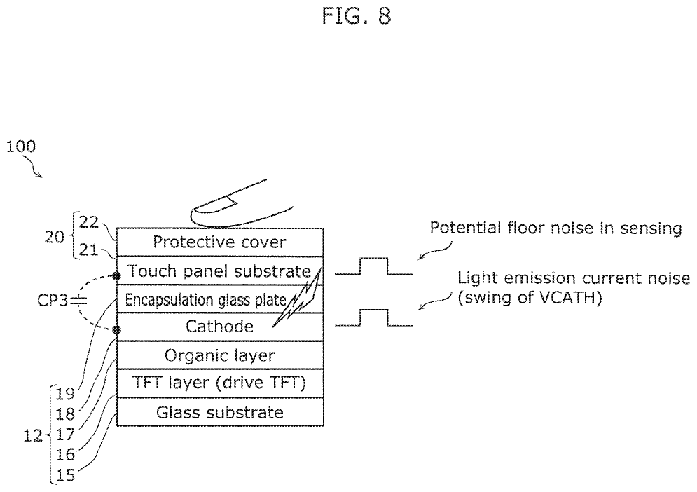

An effect of the parasitic capacitances on the sensing performance of the touch panel 20 will next be described with reference to FIGS. 7 and 8. FIG. 7 is a circuit diagram showing an example of the configuration of each of the pixel circuits 11 according to the present embodiment.

Parasitic capacitances CP3_{R}, CP3_{G}, and CP3_{B} are present between the negative power supply line VCATH and the scan electrode Tx of the touch panel 20, as shown in FIG. 7. In the following description, the parasitic capacitances CP3_{R}, CP3_{G}, and CP3_{B} are collectively referred to as a parasitic capacitance CP3 in some cases.

An effect of the presence of the parasitic capacitance CP3 shown in FIG. 7 will be described with reference to FIG. 8. FIG. 8 is a second view for describing the problem with the display device according to the related art.

Since the light emission current (pixel current) flows through the cathode 18 on the illuminating pixel region of the display panel 12, the VCATH potential at the cathode 18, which is a DC voltage input, varies due to the light emission current having flowed into the cathode 18, as shown in FIG. 8. The swing of the VCATH potential (voltage noise) increases base noise (floor noise) that affects the sensing performed by the touch panel 20, and the S/N ratio in the sensing decreases accordingly. That is, the sensing performance of the touch panel 20 lowers. For example, the detection signal acquired when the touch panel 20 supplies the Tx driving pulses to the scan electrode Tx disposed in a position where the scan electrode Tx overlaps with the illuminating pixel region in the display panel 12 in the plan view is a signal containing the base noise described above.

To solve the problem described above, the inventor of the present application has focused on that fact that, in the display device according to the related art, the operation of driving the touch panel 20 (sequential sensing in scan direction) is asynchronous with the operation of driving the display panel 12 (gate line (scan line) sequential driving in scan direction) and conducted a study. As a result of an intensive study, the present inventor has found that the display device 100 and the method for controlling the display device 100 described below solve the problem described above.

Specifically, the inventor of the present application has found a display device 100 and a method for controlling the display device 100 capable of improving both the display quality and the sensing performance as compared with those in the related art.

### [1-2. Action of Display Device]

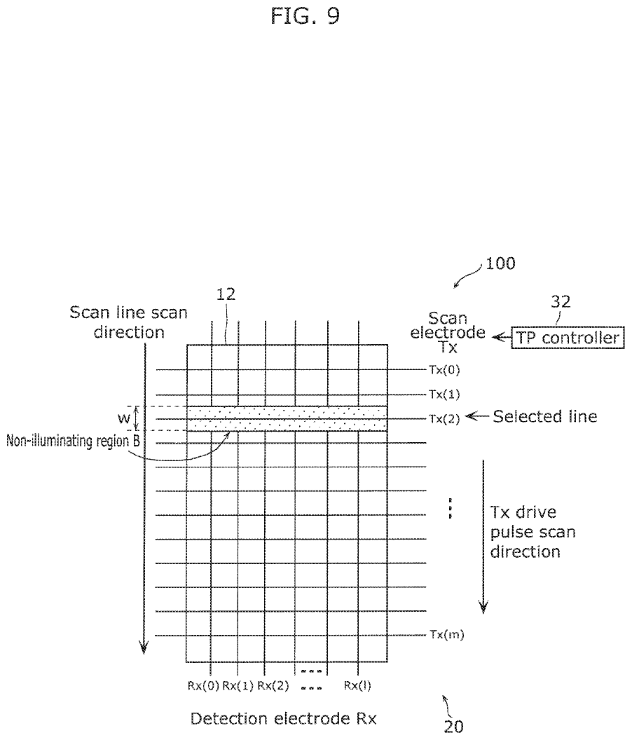

The action of the display device 100 will next be described with reference to FIGS. 9 to 11. FIG. 9 is a plan view diagrammatically showing the action of the display device 100 according to the present embodiment. FIG. 9 only shows the scan electrodes Tx and the detection electrodes Rx of the touch panel 20. The direction of the scanning performed by the touch panel 20 is, for example, the direction from above to below in the plane of view of FIG. 9, as shown by the Tx driving pulse scan direction in FIG. 9. The direction of the scanning performed by the display panel 12 is, for example, the direction from above to below in the plane of view of FIG. 9, as shown by the scan line (gate line) scan direction in FIG. 9. That is, the direction of the scanning performed by the touch panel 20 and the direction of the scanning performed by the display panel 12 are the same direction.

The TP controller 32 supplies the scan signals to the scan electrode Tx (Tx(2), which is the selected line, in the example of FIG. 9) so located as to overlap with at least part of a non-illuminating region B (dot-hatched region in FIG. 9), which is formed of one or more non-illuminating pixel rows L (pixel rows that are not illuminating), among the plurality of pixel rows L in the display panel 12, as shown in FIG. 9. The TP controller 32, for example, selects a scan electrode Tx in accordance with the position of the non-illuminating region B in such a way that the scanning performed by the touch panel 20 follows and supplies the selected scan electrode Tx with the scan signal. The word “non-illuminating” is an example of the black display being performed. The word “non-illuminating” in the description further means that no light emission current practically flows through the light emitting element of the non-illuminating pixel. The non-illuminating region B is a band-shaped region (black band) formed of one or more pixel rows L adjacent to each other.

At this point, the pixel row L that forms the non-illuminating region B of the display panel 12 is affected by the noise (see FIG. 6) resulting from the Tx driving pulses (example of scan signals) supplied to the scan electrode Tx that overlaps with the non-illuminating region B. The effect is, however, smaller than the effect of the noise resulting from the Tx driving pulses supplied to a scan electrode Tx that overlaps with an illuminating region (region of display region excluding non-illuminating region B) on the pixel row L that forms the illuminating region. That is, supplying the scan electrode Tx that overlaps with the non-illuminating region B with the Tx driving pulses allows a decrease in the display quality due to the noise resulting from the Tx driving pulses to be unlikely to be visually recognized.

The touch panel 20 scans the non-illuminating region B of the display panel 12, that is, the pixel region 11 through which no light emission current flows. In the pixel contained in the pixel region 11, no light emission current flowing into the cathode 18 results in no swing of the VCATH potential due to the light emission current and in turn no base noise in the touch panel 20, whereby a decrease in the S/N ratio in the sensing can be suppressed. That is, a display device 100 having improving display quality and sensing performance as compared with those in the related art can be achieved.

FIG. 9 shows a case where the number of scan electrodes Tx is m and the number of detection electrodes Rx is I, but the numbers of scan electrodes Tx and detection electrodes Rx are not each limited to a specific number. A width w means the width of the non-illuminating region B in the column direction. The width w is not limited to a specific value and is several millimeters.

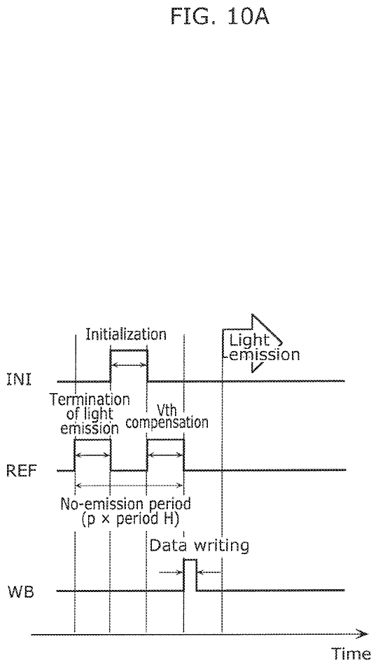

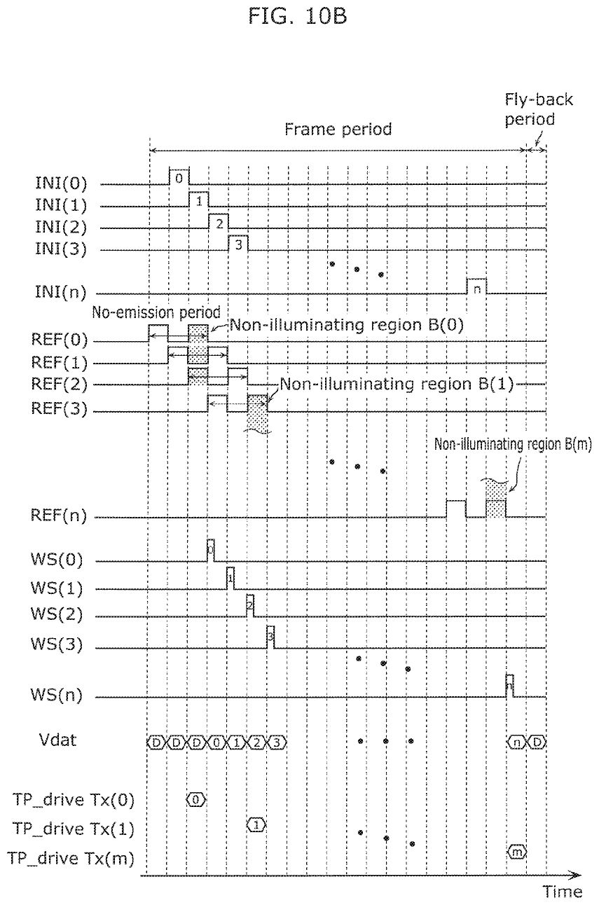

FIG. 10A is a timing chart showing an example of a method for driving a pixel circuit 11. FIG. 10A is a timing chart for one of the sub-pixels.

In a sub-pixel circuit (sub-pixel circuit 11R, for example), the holding capacity CS holds, via the data signal line Vdat, the data signal Vdat relating to the luminance of the emitted light by the sub-pixel circuit (termination of light emission, initialization, Vth compensation, and data writing), as shown in FIG. 10A. A current according to the data signal Vdat held in the holding capacity CS is output from the drive transistor TD. A no-emission period is a period for initialization setting and is specifically a period for which the sub-pixel circuit is not causing the pixel to emit light (that is, black display). Provided that the number of one or more pixel rows L that form the non-illuminating region B is p and H represents the horizontal period, the no-emission period is, for example, a period specified by p×H.

FIG. 10B is a timing chart showing an example of a method for driving a display device 100. In FIG. 10B, a numeral in parentheses attached to a signal name represents the pixel row to which the signal is supplied.

The action of the sub-pixel circuit shown in FIG. 10A is sequentially performed on a row basis in the sub-pixel circuits in all rows 0 to n in the display device 100, as shown in FIG. 10B. A non-illuminating region B(0) means that three pixel rows L are not illuminating. At this point, the TP controller 32 drives TP_drive Tx(0), which is the scan electrode Tx so located as to overlap with the non-illuminating region B(0) (region formed of pixel circuits in rows 0 to 2) in the plan view. In other words, the TP controller 32 controls the supply of the Tx driving pulses to a scan electrode Tx of the touch panel 20 in such a way that the Tx driving pulses to be performed on the scan electrode Tx so located as to overlap with one or more pixel rows L in the no-emission period. The TP controller 32, for example, controls so as to scan the scan electrode Tx that at least partially overlaps with one or more pixel rows L in the no-emission period among the plurality of pixel rows L.

The TP controller 32 then drives TP_drive Tx(1), which is the scan electrode Tx so located as to overlap with a non-illuminating region B(1) (region formed of pixel circuits in rows 3 to 5) in the plan view. As described above, the TP controller 32 sequentially drives a scan electrode Tx corresponding to the non-illuminating region B, The TP controller 32 then drives TP_drive Tx(m), which is the scan electrode Tx so located as to overlap with a non-illuminating region B(m) (region formed of pixel circuits in rows n-2 to n) in the plan view. The display panel 12 can thus display an image corresponding to one frame, and the touch panel 20 can perform the sensing action corresponding to the one frame.

As described above, in the display device 100 according to the present embodiment, the touch panel 20 performs the sensing action corresponding to one frame while the display panel 12 displays an image according to the one frame, That is, the cycle in which the display panel 12 displays an image according to one frame and the cycle in which the touch panel 20 performs the sensing action corresponding to the one frame are the same cycle. As described above, the TP controller 32 may control to cause one or more pixel rows L (non-illuminating region B, for example) to synchronize with the scan electrode Tx to which the Tx driving pulses are supplied. That is, the TP controller 32 may cause the non-illuminating (example of black display) region to synchronize with the supply of the scan signal.

The touch panel 20 performs the scanning at predetermined time intervals. FIG. 10B shows a case where the touch panel 20 performs the scanning whenever three horizontal periods (3H) elapses. The non-illuminating region B is sequentially shifted from the pixel row L(0) to the pixel row L(n) whenever one horizontal period (1H) elapses with the width w of the non-illuminating region B maintained.

“D” in the data signal Vdat in FIG. 10B means that a dummy signal is input. A fly-back period is a period contained in the externally input video signal and is a period for which the video signal scanning is caused to return from the last row to the first row. In an organic EL panel, the fly-back period is not technically necessary. However, since the video signal contains such a period, so that the display method employed by the organic EL display device needs to handle the video signal, the fly-back period is provided.

The number of plurality of scan lines may be equal to the number of plurality of scan electrodes Tx.

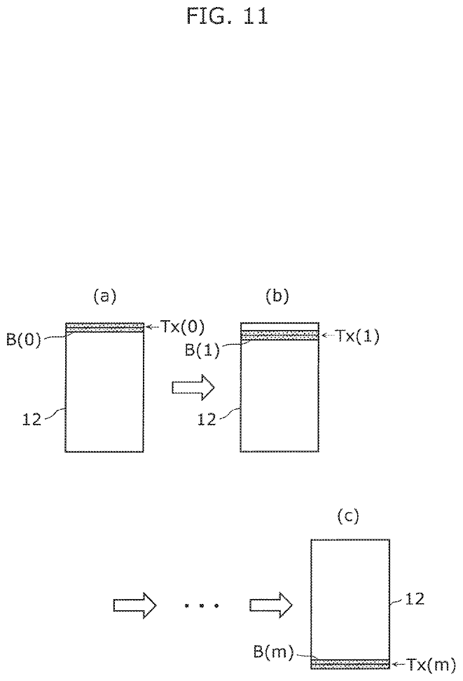

FIG. 11 is a plan view showing the time-course action of the display device 100 according to the present embodiment. FIG. 11 shows only the display panel 12 and the scan electrode Tx being scanned. The dot-hatched region in FIG. 11 represents the non-illuminating region.

The portion (a) in FIG. 11 shows that the scan electrode Tx(0) that overlaps with the non-illuminating region B(0) among the plurality of scan electrodes Tx is scanned. Specifically, the portion (a) in FIG. 11 shows that the TP_drive Tx(0) shown in FIG. 10B is scanned. The portion (b) in FIG. 11 shows that the scan electrode Tx(1) that overlaps with the non-illuminating region B(1) among the plurality of scan electrodes Tx is scanned, Specifically, the portion (b) in FIG. 11 shows that the TP_drive Tx(1) shown in FIG. 10B is scanned. The portion (c) in FIG. 11 shows that scan electrode Tx(m) that overlaps with the non-illuminating region B(m) among the plurality of scan electrodes Tx is scanned. Specifically, the portion (c) in FIG. 11 shows that the TP_drive Tx(m) shown in FIG. 10B is scanned. A plurality of non-illuminating regions B (non-illuminating region B(0), non-illuminating region B(1), . . . , non-illuminating region B(m)) are, for example, regions that do not overlap with each other in the plan view.

The TP controller 32 scans the scan electrode Tx that overlaps with a non-illuminating region B that is successively shifted whenever the horizontal period elapses and does not at least partially overlap with another non-illuminating region B, as shown in the portions (a) to (c) in FIG. 11. The TP controller 32, for example, extracts one scan electrode Tx that overlaps with the non-illuminating region B from the plurality of scan electrodes Tx based on the signals output from the DP controller 31 to the display module 10 and scans the extracted scan electrode Tx.

In FIG. 11, the description has been made of the case where the non-illuminating region B is successively shifted from above to below in the plane of view, but not necessarily. The order in which the DP controller 31 causes one or more pixel rows L contained in each of the plurality of non-illuminating regions B(0) to B(m) not to illuminate is not limited to a specific order. The plurality of non-illuminating regions B(0) to B(m) only need not to illuminate (perform black display) once in one frame period.

The case where the display panel 12 displays one non-illuminating region B at a certain point of time has been described. The display panel 12 may instead display a plurality of non-illuminating regions B so disposed as to be separate from each other at the certain point of time.

In FIG. 11, the description has been made of the case where one scan electrode Tx is formed in one non-illuminating region B, but not necessarily. For example, one non-illuminating region B may contain a plurality of scan electrodes Tx.

In this case, for example, the intervals at which the plurality of scan electrodes Tx are disposed may be smaller than or equal to w/2, where w is the width of the non-illuminating region B (width of one or more pixel rows L performing black display in the column direction, for example). As a result, the non-illuminating region on a single horizontal period basis (non-illuminating region formed of rows 0 to 2, non-illuminating region formed of rows 1 to 3, and non-illuminating region formed of rows 2 to 4, for example) is likely to overlap with at least one scan electrode Tx, That is, a situation in which part of a scan electrode Tx being scanned overlaps with an illuminating region can be suppressed. For example, when the TP controller 32 controls so as to scan a scan electrode Tx whenever one horizontal period elapses (example of predetermined time intervals), a situation in which part of the scan electrode Tx overlaps with the illuminating region can be suppressed.

### [1-3. Effects and Others]

As described above, the display device 100 according to the present embodiment includes the display panel 12, the touch panel 20 opposing the display panel 12, and the controller 30. The display panel 12 includes a plurality of pixels L arranged in rows and columns and a plurality of control signal lines (example of scan lines) respectively arranged for the rows, the plurality of control signal lines selecting, from the rows, a pixel row L to which data voltages corresponding to a video signal are to be written and which performs black display. The touch panel 20 includes a plurality of scan electrodes Tx respectively arranged in parallel to the plurality of control signal lines and receiving the Tx drive pulses (example of scan signals). The controller 30 causes the Tx drive pulses to be applied to a scan electrode Tx overlapping with the pixel row L performing the black display among the plurality of scan electrodes Tx in the plan view of the touch panel 20.

As a result, the Tx drive pulse scanning performed by the touch panel 20 is performed on a scan electrode Tx that overlaps with a pixel row L performing the black display (no-emission period), whereby any voltage noise resulting from the Tx driving pulses is unlikely to be visually recognized as the display noise. The reason for this is that the luminance of a pixel performing the black display (non-illuminating pixel) is extremely low and variation in the luminance resulting from the voltage noise is unlikely to be visually recognized as compared with variation in the luminance resulting from the voltage noise that occurs when the pixel is illuminating and the light emission current fully flows. That is, a decrease in the display quality of the display panel 12 can be suppressed.

Further, since the touch panel 20 performs the sensing on a pixel row L through which no light emission current flows, the amount of swing of the VCATH voltage (voltage noise) resulting from the light emission current decreases in the sensing target region (black-display region), resulting in a decrease in the floor noise in the Tx drive pulse scanning. That is, a decrease in the sensing performance of the touch panel 20 (decrease in S/N ratio) can be suppressed.

The display device 100 can thus improve the display quality and the sensing performance as compared with a case where the Tx drive pulses are supplied to a scan electrode Tx so located as to overlap with an illuminating region.

For example, the controller 30 further causes the black display and the application of the Tx drive pulses to be performed in synchronization with each other.

As a result, the display action and the sensing action can both be performed in one frame period. That is, the display quality and the sensing performance can be improved without providing a display period and a sensing period separately from each other.

For example, the plurality of scan electrodes Tx are arranged at intervals each being less than or equal to w/2, where w is a total width of a pixel row L performing the black display among the rows in a column direction.

Since the display device 100 can thus suppress the situation in which part of a scan electrode Tx being scanned overlaps with an illuminating region, the display quality and the sensing performance can be further improved.

For example, the plurality of pixels that form the plurality of pixel rows L each include an organic EL element or a QLED element.

The display device 100 is thus used as a display device 100 including the display panel 12 through which light emission current for causing a light emitting element, such as an organic EL element or a QLED element, to emit light flows. That is, using the display device 100 as a display device 100 including a light emitting element that is likely to produce noise allows effective improvement in the display quality and the sensing performance.

As described above, the method for controlling the display device 100 according to the present embodiment is a method for controlling the display device 100 including the display panel 12 and the touch panel 20 opposing the display panel 12. The display panel 12 includes a plurality of pixels L arranged in rows and columns and a plurality of control signal lines respectively arranged for the rows, the plurality of control signal lines selecting, from the rows, a pixel row L to which data voltages corresponding to a video signal are to be written and which performs black display. The touch panel 20 includes a plurality of scan electrodes Tx respectively arranged in parallel to the plurality of control signal lines and receiving the Tx drive pulses. The method for controlling the display device 100 causes the Tx drive pulses to be applied to a scan electrode Tx overlapping with the pixel row L performing the black display among the plurality of scan electrodes Tx in the plan view of the touch panel 20.

The method for controlling the display device 100 therefore provides the same effects as those provided by the display device 100 described above.

### Embodiment 2

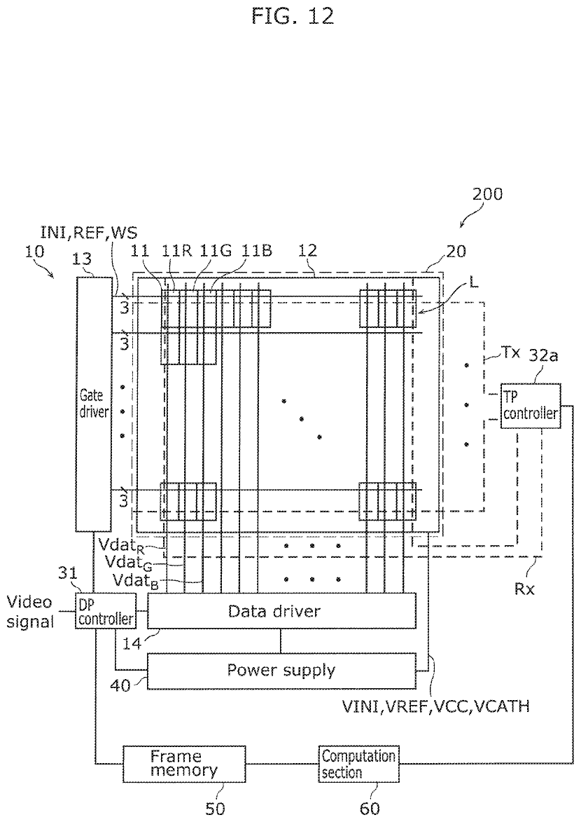

A display device and others according to the present embodiment will be described below with reference to FIGS. 12 to 15. As described in Embodiment 1, scanning a scan electrode Tx of the touch panel 20 that overlaps with one or more pixel rows L performing the black display in the plan view allows reduction in panel noise resulting from the pixel current in the display panel 12 and hence improvement in the sensing performance of the touch panel 20. That is, the TP scan can be performed with precision by causing a TP scan period for which a scan electrode Tx that overlaps with one or more pixel rows L in the plan view is scanned to coincide (synchronize) with the no-emission period in the one or more pixel rows.

In this case, however, the TP scan period is short and it is therefore necessary to operate a sensing circuit (TP controller 32a, for example) of the touch panel 20 at high speed, resulting in increases in electric power consumed by the circuit and the amount of heat generated in the module. The increase in electric power consumed by the circuit includes an increase in size of each of the transistors and an increase in active electric power. Active electric power W can be calculated by the following Expression (1), in which c represents the load capacity of each of the scan electrodes Tx, v represents the power supply voltage, and f represents the number of charge/discharge actions per second.

W=c×v²×f (Expression 1)

According to Expression 1, the active electric power W increases in proportion to an increase in the number of charge/discharge actions f. The number of charge/discharge actions f is a drive frequency into which the period for which one scan electrode Tx is selected (scan period) is converted.

In view of the fact described above, the description of the present embodiment will be made, for example, of a display device and others capable of performing the TP scan with precision with increases in electric power consumed by the circuit and the amount of heat generated in the module suppressed. The display device according to the present embodiment is characterized in that the display device has a high-precision scan mode in which the touch panel 20 performs the scanning with precision and a low-power-consumption scan mode in which the TP scan period is longer than that in the high-precision scan mode (that is, drive frequency is lower than in high-precision scan mode) and the two scan modes are switched from one to the other in accordance with the illuminating state of a displayed image (tone level). The following description will be primarily made of differences from Embodiment 1, and the same configurations as those in Embodiment 1 have the same reference characters and will not be described or described in a simplified manner in some cases.

The high-precision scan mode is an example of a first scan mode, and the low-power-consumption scan mode is an example of a second scan mode,

### [2-1. Configuration of Display Device]

The configuration of the display device according to the present embodiment will be described with reference to FIG. 12. FIG. 12 is a block diagram showing an example of a functional detailed configuration of a display device 200 according to the present embodiment.

A display device 200 according to the present embodiment includes a frame memory 50 and a computation section 60 in addition to the display device 100 according to Embodiment 1, as shown in FIG. 12. The display device 200 according to the present embodiment includes a TP controller 32a in place of the TP controller 32 of the display device 100 according to Embodiment 1.

The TP controller 32a performs control in the sensing scan performed by the touch panel 20 based on a video signal in addition to the control performed by the TP controller 32 according to Embodiment 1. The TP controller 32a performs control in the sensing scan performed by the touch panel 20 based, for example, on tone data (that is, brightness of image) in the video signal. The tone data in the video signal may be the tone data in the video signal having undergone predetermined signal processing.

The TP controller 32a according to the present embodiment switches the high-precision scan mode and the low-power-consumption scan mode from one to the other based on the tone data in the video signal. It can also be said that the high-precision scan mode is a high-frequency scan mode in which the TP scan period is shorter than in the low-power-consumption scan mode (that is, drive frequency is higher than in low-power-consumption scan mode). The drive frequency in the low-power-consumption scan mode may be three fourths the drive frequency in the high-precision scan mode or lower, or, for example, two thirds the drive frequency in the high-precision scan mode or lower, or, for example, half the drive frequency in the high-precision scan mode or lower.

In the high-precision scan mode, the TP controller 32a causes the TP scan period for which the scan electrode Tx so located as to overlap with a pixel row L is scanned to coincide with the no-emission period in the pixel row L (black display period). It can also be said that the TP controller 32a causes the no-emission period in a pixel row L to synchronize with the TP scan period for which the scan electrode Tx so located as to overlap with the pixel row L is scanned. As described above, in the high-precision scan mode, the TP scan period may overlap only with the no-emission period out of the no-emission period and the light emitting period. The situation in which the TP scan period overlaps only with the no-emission period includes a situation in which the TP scan period and the no-emission period are the same period and a situation in which the TP scan period is shorter than the no-emission period and contained in the no-emission period.

In the low-power-consumption scan mode, the TP controller 32a, for example, causes the TP scan period to coincide with the following in a pixel row L: the no-emission period; and a period which is at least part of the period before or after the no-emission period and for which a video is displayed based on the video signal. It can also be said that the TP controller 32a causes, for example, the no-emission period in a pixel row L and the light emitting period before or after the no-emission period to synchronize with the TP scan period for which the scan electrode Tx so located as to overlap with the pixel row L is scanned. As described above, in the low-power-consumption scan mode, the TP scan period may overlap with at least part of each of the no-emission period and the light emitting period. Since the scan is performed for the entire light emitting period in the low-power-consumption scan mode, the TP scan period is longer accordingly than in the high-precision scan mode.

In the high-precision scan mode, the TP scan period does not necessarily overlap only with the no-emission period. In the high-precision scan mode, the drive frequency only needs to be higher than in the low-power-consumption scan mode, and at least part of the TP scan period only needs to overlap with the no-emission period. The width of the TP scan period that overlaps with the no-emission period in the high-precision scan mode is longer than the width of the TP scan period that overlaps with the no-emission period in the low-power-consumption scan mode.

The frame memory 50 is a memory for storing a video signal received by the display device 200. The frame memory 50 stores, for example, a video signal received by the DP controller 31 under the control of the DP controller 31. The frame memory 50 has a storage capacity capable of storing, for example, at least a video signal corresponding to one frame.

The computation section 60 reads the video signal from the frame memory 50 and determines the scan mode in the TP controller 32a based on the read video signal.

The frame memory 50 may be built in the DP controller 31. The DP controller 31 may carry out the process in the computation section 60. The computation section 60 may be contained in the controller 30 (see FIG. 1).

### [2-2. Action of Display Device]

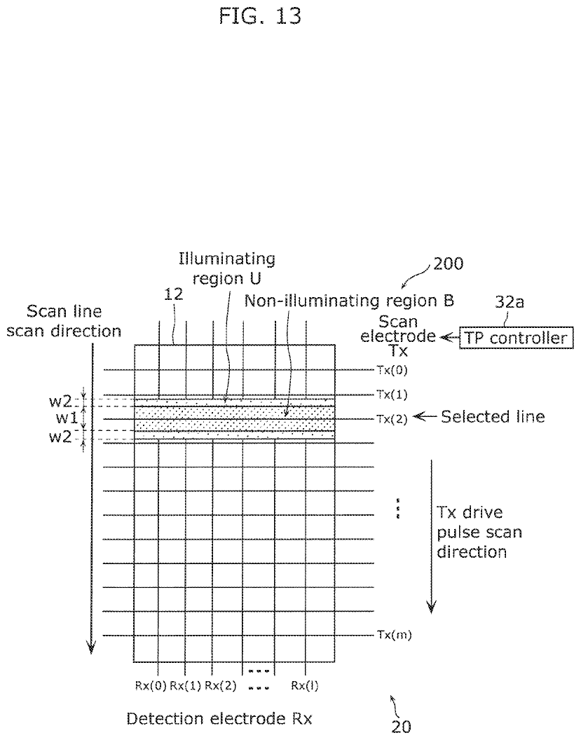

The action of the display device 200 will next be described with reference to FIGS. 13 to 15. The low-power-consumption scan mode will first be described with reference to FIG. 13. FIG. 13 is a plan view diagrammatically showing the action of the display device 200 according to the present embodiment. FIG. 13 shows only the scan electrodes Tx and the detection electrodes Rx out of the components of the touch panel 20. The non-illuminating region B and illuminating regions U shown in FIG. 13 successively move along the scanline scan direction (downward in the plane of view, for example). The non-illuminating region B indicates, for example, a black display region, and the illuminating regions U each indicate a region where a video based on the video signal is displayed.

The TP controller 32a controls so as to supply the scan signal to a scan electrode Tx(2), which is the selected line, for a period corresponding to the non-illuminating region B and the illuminating regions U above and below the non-illuminating region B in the plan view of the touch panel 20, as shown in FIG. 13.

For example, the TP controller 32a supplies the scan signal to the scan electrode Tx(2), which is the selected line, for a continuous period including both the no-emission period and the light emitting period out of the period from a first point of time when the scan-line-scan-direction-side end of the lower illuminating region U coincides with the scan electrode Tx(2), which is the selected line, to a second point of time when an end of the upper illuminating region U that is the end opposite the scan-line-scan-direction-side coincides with the scan electrode Tx(2), which is the selected line. The TP controller 32a may instead supply the scan signal to the scan electrode Tx(2), which is the selected light, for example, for the period from the first point of time to the second point of time.

A width w1 is the width of the non-illuminating region B in the column direction, specifically, the width according to the number of pixel rows that form the non-illuminating region B. The width w1 is, for example, equal to the width w shown in FIG. 9. A width w2 is the width of each of the illuminating regions U in the column direction, specifically, the width according to the number of pixel rows that form the illuminating region U. The width w2 is, for example, set in advance. For example, the width w2 is so set that the sum of the widths w1 and w2 is smaller than or equal to the interval between the scan electrodes Tx. The width w2 may be smaller than the width w1 from the viewpoint of suppression of a decrease in the sensing performance of the touch panel 20. That is, the no emission period and the light emitting period that overlap with the TP scan period may be so set that the no-emission period is longer than the light emitting period.

The period for which the TP controller 32a supplies the scan electrode Tx(2), which is the selected line, with the scan signal is not limited to the period corresponding to both the illuminating regions U located above and below the non-illuminating region B. The period for which the TP controller 32a supplies the scan electrode Tx(2) which is the selected line, with the scan signal may, for example, be the period from a first point of time when the scan-line-scan-direction-side end of the lower illuminating region U coincides with the scan electrode Tx(2), which is the selected line, to a second point of time when an end of the non-illuminating region B that is the end opposite the scan-line-scan-direction-side coincides with the scan electrode Tx(2), which is the selected line. The period for which the TP controller 32a supplies the scan electrode Tx(2) which is the selected line, with the scan signal may, for example, be the period from a first point of time when the scan-line-scan-direction-side end of the non-illuminating region B coincides with the scan electrode Tx(2), which is the selected line, to a second point of time when an end of the upper illuminating region U that is the end opposite the scan-line-scan-direction-side coincides with the scan electrode Tx(2), which is the selected line.

In the high-precision scan mode, for example, the scan signal is supplied to the scan electrode Tx(2), which is the selected line, for the period corresponding to the non-illuminating region B out of the non-illuminating region B and the illuminating regions U above and below the non-illuminating region B shown in FIG. 13. The TP controller 32a supplies the scan signal to the scan electrode Tx(2), for example, for the period from a first point of time when the scan-line-scan-direction-side end of the non-illuminating region B coincides with the scan electrode Tx(2), which is the selected line, to a second point of time when an end of the non-illuminating region B that is the end opposite the scan-line-scan-direction-side coincides with the scan electrode Tx(2), which is the selected line,

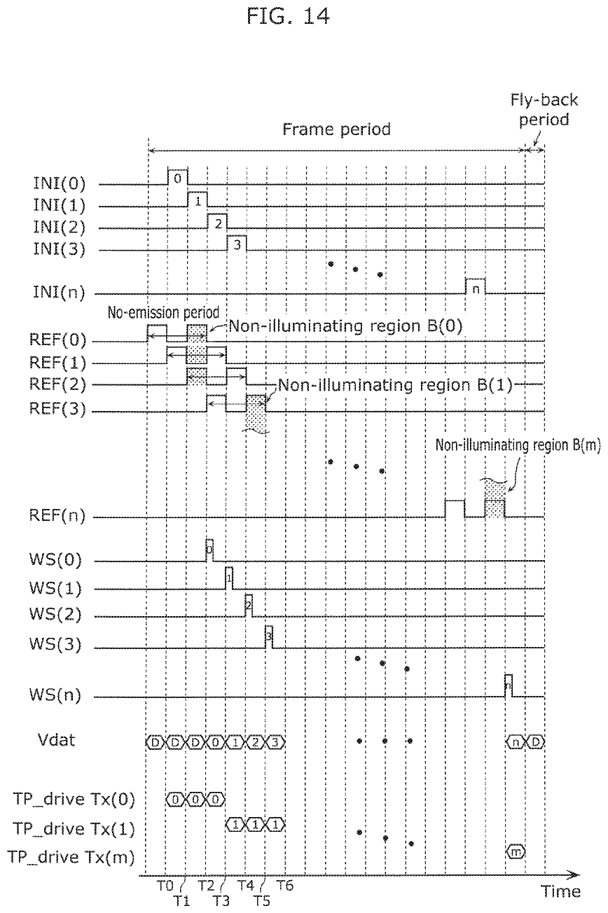

FIG. 14 is a timing chart showing an example of the method for driving the display device 200 according to the present embodiment. Specifically, FIG. 14 is a timing chart in the low-power-consumption scan mode. The timing chart in the high-precision scan mode is the same as that shown in FIG. 10B and will not be described. The numeral in parentheses attached to a signal name described in FIG. 14 represents a pixel row to which the signal is supplied, TP_drive Tx(0) shown in FIG. 14 means the scan electrode Tx(0), and TP_drive Tx(1) means the scan electrode Tx(1).

The action of the pixel circuit is sequentially performed on a row basis in the pixel circuits in all rows 0 to n in the display device 200, as shown in FIG. 14. A non-illuminating region B(0) means that three pixel rows L are not illuminating. That is, the non-illuminating region B(0) is a region formed of the pixel rows in the rows 0 to 2. At this point, the TP controller 32a drives the TP_drive Tx(0), which is the scan electrode Tx so located as to overlap with the non-illuminating region B(0) in the plan view. The TP controller 32a supplies the scan electrode Tx(0) with the scan signal, for example, from time T0 to time T3. The period from the time T0 to time T1 is the light emitting period for which the row 2 illuminates, the period from the time T1 to time T2 is the no-emission period for which the rows 0 to 2 do not illuminate, and the period from the time T2 to the time T3 is the light emitting period for which the row 0 illuminates. That is, the row 0 or 2 emits light for part of the period for which the scan electrode Tx(0) is driven.

The same holds true for the TP_drive Tx(1) and other TP_drives, as shown in the period from the time 13 to time T6.

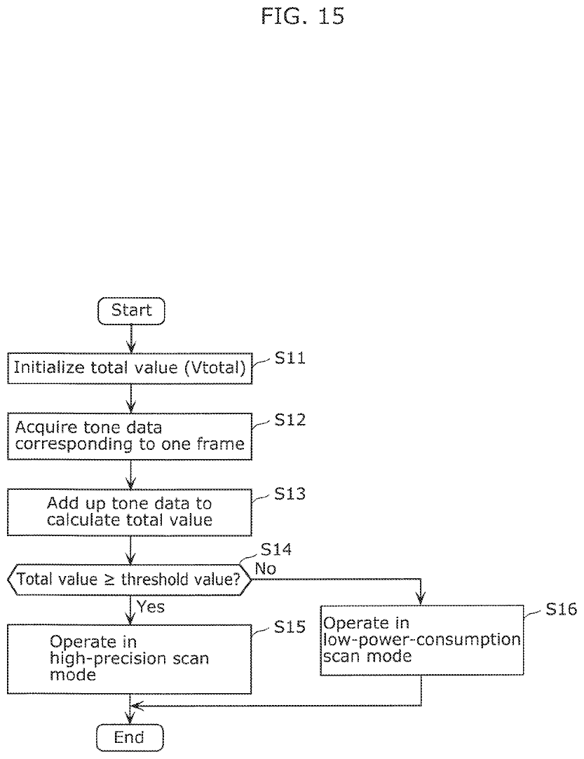

A description of the action of switching the high-precision scan mode to the low-power-consumption scan mode and vice versa will next be described with reference to FIG. 15. FIG. 15 is a flowchart showing the action of switching the scan mode in the display device 200 according to the present embodiment.

The computation section 60 initializes a total value (Vtotal) (S11), as shown in FIG. 15. That is, the total value is initialized whenever the scan mode switching action is performed. The total value may be initialized, for example, to “0”. The total value is a value used to evaluate whether or not the scan mode is switched and is a value based, for example, on the video signal.

The computation section 60 then acquires the tone data corresponding to one frame (S12). The computation section 60, for example, reads the video signal corresponding to one frame from the frame memory 50 to acquire the tone data of the video signal.

The computation section 60 then adds up the tone data corresponding to one frame to calculate a total value (S13). The total value is a value based on the totaled tone data. The tone value is, for example, the totaled tone data. In the present embodiment, the total value is the totaled tone data for each of the sub-pixel circuits 11R, 11G, and 11B. The totaled value may be calculated based on the following expression (2), in which (x(a), y(b)) represents the position of the pixel circuit, Vr(x(a), y(b)), Vg(x(a), y(b)), and Vb(x(a), y(b)) represent the tone data in the sub-pixel circuits 11R, 11G, and 11B in the positions (x(a), y(b)), n represents the number of pixel columns, and m represents the number of pixel rows.

VTotal=Σ_{a=1,b=1}^{n,m}(Vr(x(a),y(b))+Vg(x(a),y(b))+Vb(x(a),y(b))) (Expression 2)

The total value may instead be the number of pixel circuits or sub-pixel circuits that provide tone data greater than or equal to predetermined tone data. The predetermined tone data may, for example, be a value corresponding to V255 in a case where the predetermined tone data is expressed in 8 bits. In the case where the predetermined tone data is expressed in 8 bits, the predetermined tone data may, for example, be V200, V220, or V240. The predetermined tone data is not limited thereto and may be determined as appropriate based, for example, on the relationship between the tone data and the current.

The computation section 60 may calculate the total value by weighting and adding the tone data for each of the sub-pixel circuits 11R, 11G, and 11B. The computation section 60 may calculate the total value by using the tone data from at least one of the sub-pixel circuits 11R, 11G, and 11B. The computation section 60 may calculates the total value, for example, by using only the tone data from a sub-pixel circuit through which the largest amount of current flows when the white display is performed (sub-pixel circuit 11B, for example) among the sub-pixel circuits 11R, 11G, and 116.

The computation section 60 then compares the calculated total value with a threshold value. The computation section 60, for example, evaluates whether or not the total value is greater than or equal to the threshold value (S14).

The threshold value is set in advance and stored in a memory (not shown). The threshold value may be set at a large value from the viewpoint of further reduction in power consumption and may, for example, be 80%. The threshold value may be set at a small value from the viewpoint of high-precision sensing and may, for example, be 20%. The threshold value may be set from the viewpoint of a good balance between the power consumption and high-precision sensing and may, for example, be 50%. As described above, the threshold value may be determined as appropriate in accordance with the application of the display device and other factors.

In the case where the total value is the totaled tone data, the computation section 60 may compare the ratio of the total value to a multiple of the maximum of the tone data (tone data V255 multiplied by the number of pixel circuits in the case of 8 bits, for example) with the threshold value. In the case where the total value is the number of pixel circuits having tone data greater than or equal to predetermined tone data, the computation section 60 may compare the ratio of the number of pixel circuits to the total number of the pixel circuits with the threshold value. As described above, the computation section 60 has the function as an evaluator.

In a case where the total value is greater than or equal to the threshold value (Yes in S14), the computation section 60 outputs information representing that the total value is greater than or equal to the threshold value to the TP controller 32a. Having acquired the information, the TP controller 32a operates in the high-precision scan mode (S15). In a case where an image displayed by the display panel 12 has a large proportion of high-tone portions, the TP controller 32a operates in the high-precision scan mode. The TP controller 32a, far example, performs the TP scan for a black-display H period.

As a result, in a case where the image displayed by the display panel 12 is bright and the panel noise resulting from the pixel current is large, that is, in a case where the touch panel 20 is subject to the panel noise, the TP controller 32a operates in the high-precision scan mode and can therefore perform the sensing with precision. The information representing that the total value is greater than or equal to the threshold value may instead be information that instructs the TP controller 32a to operate in the high-precision scan mode.

In a case where the total value is smaller than the threshold value (No in S14), the computation section 60 outputs information representing that the total value is smaller than the threshold value to the TP controller 32a. Having acquired the information, the TP controller 32a operates in the low-power-consumption scan mode (S16). In a case where the image displayed by the display panel 12 has a large proportion of intermediate-tone and low-tone portions, the TP controller 32a operates in the low-power-consumption scan mode. The TP controller 32a, for example, performs the TP scan for a black-display H period and a light emitting H line period.

As a result, in a case where the image displayed by the display panel 12 is dark and the panel noise resulting from the pixel current is small, that is, in a case where the touch panel 20 is not subject to the panel noise, the TP controller 32a operates in the low-power-consumption scan mode, whereby the electric power consumed by the circuit and the amount of heat generated in the module can be reduced with a decrease in the sensing precision suppressed. The information representing that the total value is smaller than the threshold value may instead be information that instructs the TP controller 32a to operate in the low-power-consumption scan mode.

In FIG. 15, the description has been made of the case where the scan mode of the touch panel 20 is switched based on the total value, but not necessarily. The computation section 60 may switch the scan mode of the touch panel 20 based on the tone level of a video signal. The computation section 60 may calculate a statistic value of the tone data as the value used to evaluate whether or not the scan mode is switched. The statistic value contains at least one of the average, median, maximum, minimum, and others of the tone data. The computation section 60 may then compare the calculated statistic value with the threshold value and switch the scan mode of the touch panel 20 based on the result of the comparison.

The flowchart shown in FIG. 15 is carried out on a frame basis, but not necessarily. The flowchart shown in FIG. 15 may be carried out on a multiple frame basis, on an odd or even frame basis, or on a predetermined time interval basis.

### [2-3. Effects and Others]

As described above, the TP controller 32a of the display device 200 according to the present embodiment has, as a scan mode of the display device 200, the high-precision scan mode and the low-power-consumption scan mode including the drive frequency lower than the drive frequency of the high-precision scan mode, the high-precision scan mode being a mode in which the scan signal is applied to a scan electrode Tx overlapping a pixel row L performing the black display, and the low-power-consumption scan mode being a mode in which the scan signal is applied to a scan electrode Tx in a first period and a second period in the pixel row L, the scan electrode overlapping the pixel row L, the first period being a period in which the pixel row performs the black display, the second period being a period in which the pixel row performs video display based on a video signal, and the second period being at least one of periods before and after the first period. The TP controller 32a selectively switches between the high-precision scan mode and the low-power-consumption scan mode in accordance with the tone level of the video signal.

The TP controller 32a is an example of a controller. The high-precision scan mode is an example of a first scan mode, and the low-power-consumption scan mode is an example of a second scan mode.

The display device 200 thus has the low-power-consumption scan mode, which allows a low drive frequency and suppression of increases in the electric power consumed by the circuit and the amount of heat generated in the module. The display device 200 can suppress the electric power consumed by the circuit and the amount of heat generated in the module, as compared with a case where the display device always operates in the high-precision scan mode, by switching the high-precision scan mode and the low-power-consumption scan mode from one to the other based on the tone level of the video signal.

In the high-precision scan mode, the TP controller 32a causes the black display and the application of the scan signal to be performed in synchronization with each other.

The precision of the TP scan can thus be improved as compared with a case where the scan signal is supplied in a period containing the black display and the video display in the high-precision scan mode.

The TP controller 32a selects the high-precision scan mode of the touch panel 20 when the total value obtained by adding up the tone levels of the pixel circuits 11 is greater than or equal to the threshold value (Yes in S14), and selects the low-power-consumption scan mode of the touch panel 20 when the total value is smaller than the threshold value (No in S14).

Therefore, in the case where the touch panel 20 is subject to the panel noise, the TP controller 32a operates in the high-precision scan mode, whereas in the case where the touch panel 20 is not subject to the panel noise, the TP controller 32a operates in the low-power-consumption scan mode. That is, in the case where the touch panel 20 is subject to the panel noise, precise sensing can be performed, whereas in the case where the touch panel 20 is not subject to the panel noise, the electric power consumed by the circuit and the amount of heat generated in the module can be reduced.

The display device 200 can therefore reduce the electric power consumed by the circuit and the amount of heat generated in the module with a decrease in the sensing precision suppressed.

### (Variation of Embodiment 2)

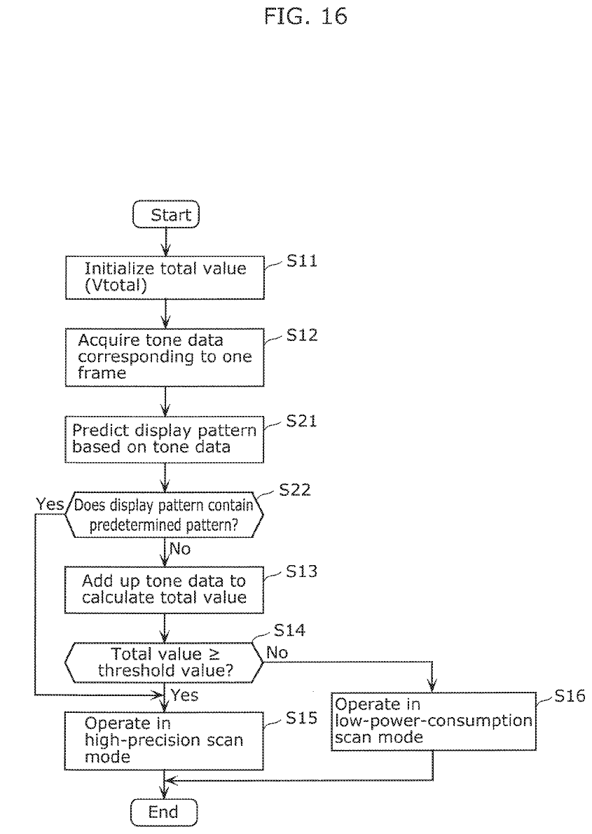

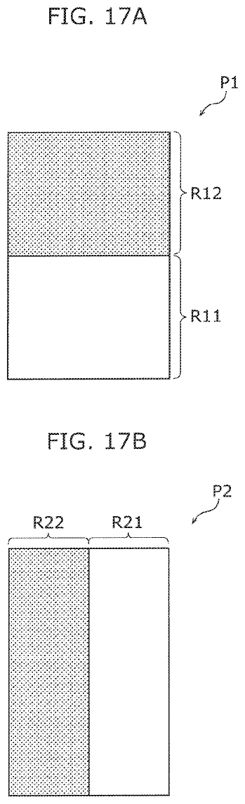

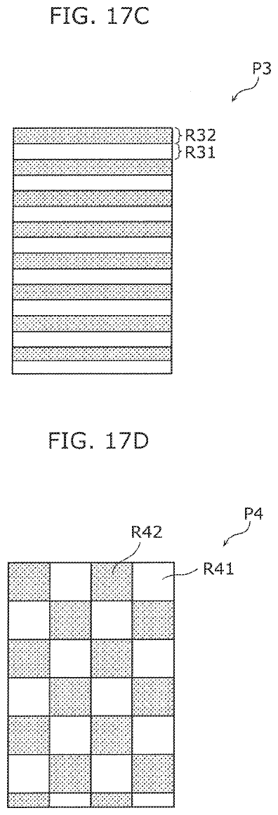

A display device and others according to the present variation will be described below with reference to FIGS. 16 to 17D. The following description will be primarily made of differences from Embodiment 2, and the same configurations as those in Embodiment 2 have the same reference characters and will not be described or described in a simplified manner in some cases. The configuration of the display device according to the present variation is the same as that of the display device 200 according to Embodiment 2 and will not be described. The action of the display device 200 according to the present variation will be described below with reference to FIG. 16. FIG. 16 is a flowchart showing the action of switching the scan mode in the display device 200 according to the present variation.

The computation section 60 acquires tone data corresponding to one frame (S12) and predicts a display pattern based on the tone data (S21), as shown in FIG. 16. The computation section 60 may predict the display pattern, for example, from the distribution of the tone data in mapped data in which the tone data is mapped. The computation section 60 may instead, for example, perform binarization based on whether or not the tone data is greater or equal to predetermined tone data and predict the display pattern from the binarized black-and-white distribution.

The computation section 60 then evaluates whether or not the display pattern predicted in step S21 contains a predetermined pattern (S22). The computation section 60 may, for example, compare the predicted display pattern with a predetermined pattern set in advance to perform the evaluation in step S22. For example, in a case where the display pattern is the same as or similar to the predetermined pattern, the computation section 60 may determine that the display pattern contains the predetermined pattern. The computation section 60 may instead compare a display pattern for each of a plurality of blocks to which the display region of the display panel 12 is segmented (divided) with the predetermined pattern. For example, in a case where the number of blocks in which the display pattern is the same as or similar to the predetermined pattern is greater than or equal to a predetermined number, the computation section 60 may determine that the display pattern contains the predetermined pattern. The predetermined number is, for example, one but not limited thereto.

The predetermined pattern is, for example, a display pattern that is not frequently displayed in typical video display operation. The predetermined pattern will be described with reference to FIGS. 17A to 17D. FIG. 17A shows a first example of a predetermined pattern P1. FIG. 17E3 shows a second example of a predetermined pattern P2. FIG. 17C shows a third example of a predetermined pattern P3. FIG. 17D shows a fourth example of a predetermined pattern P4. FIGS. 17A to 17D each show a region performing the dark display in the form of a dot-hatched region.

The predetermined pattern P1 is a display pattern in which a bright image is displayed in a first region R11, which is one of the upper and lower regions of the display panel, and a dark image is displayed in a second region R12, which is the other one of the upper and lower regions of the display panel, as shown in FIG. 17A. In this case, the panel noise affects the touch panel 20 in the first region R11 by a large amount, and the panel noise affects the touch panel 20 in the second region R12 by a small amount. The first region R11 is, for example, a region where the tone level is greater than or equal to a predetermined level, and the second region R12 is, for example, a region where the tone level is smaller than the predetermined level.

The predetermined pattern P2 is a display pattern in which a bright image is displayed in a first region R21, which is one of the right and left regions of the display panel, and a dark image is displayed in a second region R22, which is the other one of the right and left regions of the display panel, as shown in FIG. 17B. In this case, the panel noise affects the touch panel 20 in the first region R21 by a large amount, and the panel noise affects the touch panel 20 in the second region R22 by a small amount.

In FIGS. 17A and 17B, a portion close to the center of the display panel in the upward/downward direction or the rightward/leftward direction is the boundary between the bright portion and the dark portion, but the position of the boundary between the bright portion and the dark portion is not limited to a portion close to the center. The ratio between the area of the bright image and the area of the dark image is not limited to a specific value. It can be said that display patterns each having a position of the boundary between the bright portion and the dark portion and the area ratio different from those in FIGS. 17A and 17B are similar to the predetermined patterns P1 and P2.

The predetermined pattern P3 is a display pattern in which a first region R31, which is a bright region, and a second region R32, which is a dark region, are alternately (periodically, for example) disposed in a single image, as shown in FIG. 17C. The predetermined pattern P3 is a display pattern in which bright and dark regions are alternately disposed along a predetermined direction and there is no bright/dark change along a direction that intersects the predetermined direction (direction perpendicular thereto, for example). In this case, a region affected by the panel noise by a large amount and a region affected by the panel noise by a small amount are alternately disposed in a single image. FIG. 17C shows a case where the first region R31 and the second region R32 are alternately disposed in the upward/downward direction, and it is noted that the predetermined pattern P3 also includes a display pattern in which the first region R31 and the second region R32 are alternately disposed in the rightward/leftward direction or an oblique direction. It can be said that a display pattern in which the shapes of the first region R31 and the second region R32 differ from those in FIG. 17C or the ratio between the area of the first region R31 and the area of the second region R32 differs from the ratio in FIG. 17C is similar to the predetermined pattern P3.

The predetermined pattern P4 is a display pattern in which a first region R41, which is a bright region, and a second region R42, which is a dark region, are arranged in a zigzag pattern, as shown in FIG. 17D. The predetermined pattern P4 is a display pattern in which bright and dark regions are alternately disposed along a predetermined direction and the bright and dark regions are also alternately disposed along a direction that intersects the predetermined direction (direction perpendicular thereto, for example). In this case, a region affected by the panel noise by a large amount and a region affected by the panel noise by a small amount are arranged in a zigzag pattern in a single image. It can be said that a display pattern in which the shapes of the first region R41 and the second region R42 differ from those in FIG. 17D or the ratio between the area of the first region R41 and the area of the second region R42 differs from the ratio in FIG. 17D is similar to the predetermined pattern P4.

In the display patterns shown in FIGS. 17A to 17D described above, determining the scan mode based on the tone data as in Embodiment 2 causes a decrease in the TP scan performance of the touch panel 20 in some cases. The reason for this will be described below with reference to the display pattern shown in FIG. 17A. In a case where the result of the evaluation shows that the display device operates in the low-power-consumption scan mode based on the tone data, the panel noise greatly affects the first region RU, so that the touch panel 20 cannot perform the sensing with precision.

The display device 200 according to the present variation therefore performs the evaluation in step S22 before the determination of the scan mode based on the tone data (before step S13 shown in FIG. 16, for example).

Referring to FIG. 16 again, in the case where the display pattern contains the predetermined pattern (Yes in step S22), the computation section 60 outputs information representing that the display pattern contains the predetermined pattern to the TP controller 32a. Having acquired the information, the TP controller 32a operates in the high-precision scan mode (S15). Therefore, in the case where the display pattern contains the predetermined pattern, the display device 200 operates in the high-precision scan mode without performing the evaluation using the total value, whereby the touch panel 20 can perform the TP scan with precision even when the display panel 12 displays the display pattern. The information representing that the display pattern contains the predetermined pattern may be information that instructs the TP controller 32a to operate in the high-precision scan mode.

In a case where the display pattern contains no predetermined pattern (No in step S22), the computation section 60 proceeds to step S13 and performs the evaluation using the total value.

As described above, in a case where a display image based on a video signal also contains the predetermined pattern, the TP controller 32a of the display device 200 according to the present variation switches the scan mode of the touch panel 20 to the high-precision scan mode.

The TP controller 32a is an example of the controller, and the high-precision scan mode is an example of the first scan mode.

The TP controller 32a can thus perform the TP scan with precision in the case where the display image contains the predetermined pattern. That is, in the case where the display image contains the predetermined pattern, the IP controller 32a can detect a user's operation performed on the touch panel 20 with precision.

The predetermined pattern P1 may instead be a display pattern which includes the first region RU, in which the tone level is greater than or equal to a predetermined level, and the second region R12, which is a region other than the first region R11, and in which the first region R11 and the second region R12 are so disposed to be adjacent to each other. The predetermined pattern P3 may instead be a display pattern in which the first region R31 and the second region R32 are alternately disposed in a predetermined direction. The predetermined pattern P4 may instead be a display pattern in which the first region R41 and the second region R42 are disposed in a zigzag pattern.

Therefore, in a case where a display image contains a display pattern in which the degree of the panel noise from the display panel 12 greatly varies depending on the position on a scan electrode Tx or the position of a scan electrode Tx on the touch panel 20, the TP controller 32a can perform the TP scan with precision. When a display image containing any of the predetermined patterns P1 to P4 is TP-scanned in the low-power-consumption scan mode, the TP scan cannot be performed with precision, for example, in the first region R11. Therefore, for example, even in a case where the TP controller 32a operates in the low-power-consumption scan mode in accordance with the result of the evaluation based on the totaled image data, but the display image contains any of the predetermined patterns P1 to P4, causing the TP controller 32a in the high-precision scan mode allows the TP scan to be performed with precision.

### OTHER EMBODIMENTS

Although the display device and the method for controlling the display device according to the present disclosure have been described based on the embodiments, the display device etc. according to the present disclosure are not limited to the embodiments. Those skilled in the art will readily appreciate that (i) embodiments arrived at by selectively combining elements disclosed in the above embodiments, (ii) embodiments arrived at by making various modifications to the above embodiments without materially departing from the scope of the present disclosure, or (iii) various devices including the display device etc. according to the embodiments may be included within one or more aspects of the present disclosure.

For example, the above embodiments have been described with reference to the case where the touch panel is an out-cell-type touch panel, and the touch panel may instead be an in-cell-type or on-cell-type touch panel.

The above embodiments have been described with reference to the case where the substrate and other components each comprise glass, and the substrate and other components may instead each comprise a film. The substrate may be flexible.

The display panel according to the embodiments described above may instead be a liquid crystal panel. In the liquid crystal panel, the common electrode (common metal, for example), for example, can be the noise source. It is, however, expected that applying the present application to an organic EL panel or a QLED panel provides a greater improving effect.

The application of the display device according to each of the embodiments described above is not limited to a specific application. The display device may be used, for example, in a mobile information terminal, a personal computer, and a television receiver, and even a digital signage device.

The above embodiments have been described with reference to a case where the situation in which a pixel is “not illuminating” means that no light emission current practically flows through the light emitting element of the pixel, but not necessarily. The situation in which a pixel is “not illuminating may include a case where the light emission current flowing through the light emitting element is lower than or equal to a predetermined value. The predetermined value is, for example, a current value that allows the light emitting element to emit light having luminance lower than or equal to 5% of the upper limit of the luminance of the emitted light. A pixel row performing the black display may, for example, be a pixel row having brightness lower than or equal to a predetermined value.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is widely usable as a display device including a touch panel and a method for controlling the display device in a variety of video display devices, such as a mobile information terminal, a personal computer, and a television receiver.

1. A display device, comprising:
a display panel;
a touch panel opposing the display panel; and
a controller, wherein
the display panel includes:
a plurality of pixels arranged in rows and columns; and
a plurality of scan lines respectively arranged for the rows, the plurality of scan lines selecting, from the rows, a pixel row to which data voltages corresponding to a video signal is to be written and a pixel row for performing black display,
the touch panel includes
a plurality of scan electrodes respectively elongated in parallel to the plurality of scan lines and receiving scan signals, and
the controller causes a scan signal to be applied to a scan electrode overlapping the pixel row performing the black display among the plurality of scan electrodes in a plan view of the touch panel.

2. The display device according to claim 1, wherein
the controller further causes the black display and the application of the scan signal to be performed in synchronization with each other.

3. The display device according to claim 1, wherein
the controller has, as a scan mode of the touch panel, a first scan mode and a second scan mode including a drive frequency lower than a drive frequency of the first scan mode, the controller selectively switching between the first scan mode and the second scan mode in accordance with a tone level of the video signal,
the first scan mode being a mode in which a scan signal is applied to a scan electrode among the plurality of scan electrodes, the scan electrode overlapping a pixel row performing the black display among the rows, and
the second scan mode being a mode in which a scan signal is applied to a scan electrode among the plurality of scan electrodes in a first period and a second period, the scan electrode overlapping a pixel row among the rows, the first period being a period in which the pixel row performs the black display, the second period being a period in which the pixel row performs video display based on the video signal, the second period being at least one of periods before and after the first period.

4. The display device according to claim 3, wherein
in the first scan mode, the controller causes the black display and the application of the scan signal to be performed in synchronization with each other.

5. The display device according to claim 3, wherein
the controller selects the first scan mode when a total value obtained by adding up the tone levels of the plurality of pixels is greater than or equal to a threshold value, and selects the second scan mode when the total value is smaller than the threshold value.

6. The display device according to claim 3, wherein
the controller further selects the first scan mode when display image based on the video signal includes a predetermined pattern.

7. The display device according to claim 6, wherein
the predetermined pattern includes a first region and a second region adjacent to each other, the first region including the tone level greater than or equal to a predetermined level, the second region being a region other than the first region in the predetermined pattern.

8. The display device according to claim 6, wherein
the predetermined pattern includes a first region and a second region alternately arranged in a predetermined direction, the first region including the tone level greater than or equal to a predetermined level, the second region being a region other than the first region in the predetermined pattern.

9. The display device according to claim 6, wherein
the predetermined pattern includes a first region and a second region repeatedly arranged in a zigzag, the first region including the tone level greater than or equal to a predetermined level, the second region being a region other than the first region in the predetermined pattern.

10. The display device according to claim 1, wherein
the plurality of scan electrodes are arranged at intervals each being less than or equal to w/2, where w is a total width, in a column direction, of at least one pixel row performing the black display among the rows.

11. The display device according to claim 1, wherein
each of the plurality of pixels includes one of an organic electro-luminescence (EL) element and a quantum-dot light emitting diode (QLED).

12. A control method for use in a display device, the display device including:
a display panel; and
a touch panel opposing the display panel; wherein
the display panel includes:
a plurality of pixels arranged in rows and columns;
a plurality of scan lines respectively arranged for the rows, the plurality of scan lines selecting, from the rows, a pixel row to which data voltages corresponding to a video signal is to be written and a pixel row for performing black display, and
the touch panel includes:
a plurality of scan electrodes respectively elongated in parallel to the plurality of scan lines and receiving scan signals,
the control method comprising:
applying a scan signal to a scan electrode overlapping the pixel row performing the black display among the plurality of scan electrodes in a plan view of the touch panel.
